(19) United States
(12) Patent Application Publication
(10) Pub. No.: US 2010/0249325 A1
(43) Pub. Date: Sep. 30, 2010

(54) POLYMER POWDER WITH HIGH RUBBER CONTENT AND PRODUCTION THEREOF

(75) Inventors: Marc Bothe, Limburgerhof (DE); Rajan Venkatesh, Mannheim (DE); Christian Krueger, Speyer (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/161,345

(22) PCT Filed: Jan. 12, 2007
(86) PCT No.: PCT/EP2007/050275

§ 371 Date: Jul. 18, 2008

(30) Foreign Application Priority Data
Jan. 19, 2006 (EP) 06100579.9

(51) Int. Cl. C08L 33/00

(52) U.S. Cl. 525/221; 525/55

(57) ABSTRACT

The present invention relates to polymer powders with high rubber content and to their use as impact modifiers for rigid polyvinyl chloride (PVC) applications, and also to thermoplastic molding compositions comprising halogen and comprising the polymer powder, and to the use of the molding compositions for production of moldings.

The present invention relates to polymer powders with high rubber content and to their use as impact modifiers for rigid polyvinyl chloride (PVC) applications, and also to thermoplastic molding compositions comprising halogen and comprising the polymer powder, and to the use of the molding compositions for production of moldings.

The principle of impact-modification is based on embedding of a fine-particle phase of a soft, elastic polymer into the continuous PVC phase. This “rubber phase” permits improved dissipation of energy under impact stress.

These impact modifiers are usually prepared via multistage free-radical emulsion polymerization.

They are composed of emulsion polymer particles which have a core-shell structure, where the shell is composed of a hard polymer and the core is composed of a soft, crosslinked rubber polymer.

The modifier dispersion obtainable via emulsion polymerization is converted via spray drying, or via precipitation and subsequent drying of the coagulate, to powder form and is mixed with pulverulent PVC and, if appropriate, with conventional additives.

For preparation of the rubber phase it is usual to use monomers which are capable of free-radical polymerization where the glass transition temperature of the polymer is <0° C., preferably <−40° C. The monomers usually used have been widely described, for example in EP 1201692 and EP 1541603. The materials involve C1-C18-alkyl acrylates, such as butyl acrylate, ethyl acrylate, 2-ethylhexyl acrylate, and octyl acrylate, dienes, such as butadiene and isoprene, or vinyl acetate, or copolymers of these, with one another and, for example, also with vinylaromatics, such as styrene, or else with methacrylates, acrylonitrile, acrylic acid, and methacrylic acid.

It was an object of the present invention to provide a polymer powder which has high rubber content and which can be used as impact modifier for thermoplastics comprising halogen, with content of monomers that are particularly advantageously available.

According to the invention, the object has been achieved via a

polymer powder with >50% content of crosslinked polymer A, where polymer A comprises, as monomer units,
from 1 to 50% by weight of at least one alkene which has from 2 to 12 carbon atoms [monomer A], and
from 30 to 99% by weight of at least one ester based on α,β-monoethylenically unsaturated mono- or dicarboxylic acid which has from 3 to 6 carbon atoms and on an alkanol which has from 1 to 18 carbon atoms [monomer B], and
from 0.1 to 20% by weight of at least one compound which has at least two unconjugated vinyl groups which has crosslinking action [monomer C], and also, if appropriate,
from 0 to 10% by weight of an α,β-monoethylenically unsaturated mono- or dicarboxylic acid which has from 3 to 6 carbon atoms, and/or an amide thereof [monomer D], and
from 0 to 30% by weight of an α,β-ethylenically unsaturated compound which differs from the monomers A to D [monomer E],
   and monomers A to E give a total of 100% by weight.

The invention further provides the use of the inventive polymer powders as impact modifiers for thermoplastics comprising halogen. The invention likewise provides PVC molding compositions comprising the polymer powders produced by the inventive process, and also provides molded articles produced using the resultant PVC compositions.

Amounts of from 1 to 25% by weight of the dried pulverulent impact modifier are mixed with PVC powder and with conventional additives, e.g. fillers, stabilizers, and processing aids, and are processed by conventional methods to give high-impact-resistant PVC moldings.

The polymer powder comprises emulsion polymer particles which have a core-shell structure, where the shell is composed of a hard polymer and the core is composed of a soft, crosslinked rubber polymer. These polymer powders can be used as impact modifiers for thermoplastics comprising halogen, preferably polyvinyl chloride.

The polymer of the shell is therefore advantageously compatible with polyvinyl chloride (PVC).

The inventive polymer powder is preferably produced via an aqueous free-radical emulsion polymerization.

The conduct of free-radical-initiated emulsion polymerization reactions of ethylenically unsaturated monomers in an aqueous medium has been widely described previously and is therefore well-known to the person skilled in the art [cf. in this connection emulsion polymerization in Encyclopedia of Polymer Science and Engineering, Vol. 8, pages 659 ff. (1987); D. C. Blackley, in High Polymer Latices, Vol. 1, pages 35 ff. (1966); H. Warson, The Applications of Synthetic Resin Emulsions, chapter 5, pages 246 ff. (1972); D. Diederich, Chemie in unserer Zeit 24, pages 135-142 (1990); Emulsion polymerization, Interscience Publishers, New York (1965); DE-A 40 03 422 and Dispersionen synthetischer Hochpolymerer [Dispersions of synthetic high polymers], F. Hölscher, Springer-Verlag, Berlin (1969)]. The usual method used for free-radical-induced aqueous emulsion polymerization reactions consists in dispersing the ethylenically unsaturated monomers with concomitant use of dispersing agents in an aqueous medium in the form of monomer droplets, and using a free-radical polymerization initiator to polymerize the material.

The inventive polymer powder is advantageously produced via at least two-stage aqueous free-radical emulsion polymerization. In this process, the polymer A is first prepared in the form of polymer dispersion A in at least one step, and in at least one further step a polymer B is prepared in the presence of the polymer dispersion A. The resultant polymer dispersion B preferably has a core-shell structure in which the core is formed by the polymer A and the shell by polymer B.

The monomers A used can comprise any of the linear, branched, or cyclic alkenes which have from 2 to 12 carbon atoms, preferably from 5 to 10 carbon atoms, and particularly preferably from 6 to 8 carbon atoms, and which are capable of free-radical copolymerization, and which comprise no elements other than carbon and hydrogen. Among these, by way of example, are the acyclic alkenes 2-butene, 2-methylpropene, 2-methyl-1-butene, 3-methyl-1-butene, 3,3-dimethyl-2-isopropyl-1-butene, 2-methyl-2-butene, 3-methyl-2-butene, 1-pentene, 2-methyl-1-pentene, 3-methyl-1-pentene, 4-methyl-1-pentene, 2-pentene, 2-methyl-2-pentene, 3-methyl-2-pentene, 4-methyl-2-pentene, 2-ethyl-1-pentene, 3-ethyl-1-pentene, 4-ethyl-1-pentene, 2-ethyl-2-pentene, 3-ethyl-2-pentene, 4-ethyl-2-pentene, 2,4,4-trimethyl-1-pentene, 2,4,4-trimethyl-2-pentene, 3-ethyl-2-methyl-1-pentene, 3,4,4-trimethyl-2-pentene, 2-methyl-3-ethyl-2-pentene, 1-hexene, 2-methyl-1-hexene, 3-methyl-1-hexene, 4-methyl-1-hexene, 5-methyl-1-hexene, 2-hexene, 2-methyl-2-hexene, 3-methyl-2-hexene, 4-methyl-2-hexene, 5-methyl-2-hexene, 3-hexene, 2-methyl-3-hexene, 3-methyl-3-hexene, 4-methyl-3-hexene, 5-methyl-3-hexene, 2,2-dimethyl-3-hexene, 2,3-dimethyl-2-hexene, 2,5-dimethyl-3-hexene, 2,5-dimethyl-2-hexene, 3,4-dimethyl-1-hexene, 3,4-dimethyl-3-hexene, 5,5-dimethyl-2-hexene, 2,4-dimethyl-1-hexene, 1-heptene, 2-methyl-1-heptene, 3-methyl-1-heptene, 4-methyl-1-heptene, 5-methyl-1-heptene, 6-methyl-1-heptene, 2-heptene, 2-methyl-2-heptene, 3-methyl-2-heptene, 4-methyl-2-heptene, 5-methyl-2-heptene, 6-methyl-2-heptene, 3-heptene, 2-methyl-3-heptene, 3-methyl-3-heptene, 4-methyl-3-heptene, 5-methyl-3-heptene, 6-methyl-3-heptene, 6,6-dimethyl-1-heptene, 3,3-dimethyl-1-heptene, 3,6-dimethyl-1-heptene, 2,6-dimethyl-2-heptene, 2,3-dimethyl-2-heptene, 3,5-dimethyl-2-heptene, 4,5-dimethyl-2-heptene, 4,6-dimethyl-2-heptene, 4-ethyl-3-heptene, 2,6-dimethyl-3-heptene, 4,6-dimethyl-3-heptene, 2,5-dimethyl-4-heptene, 1-octene, 2-methyl-1-octene, 3-methyl-1-octene, 4-methyl-1-octene, 5-methyl-1-octene, 6-methyl-1-octene, 7-methyl-1-octene, 2-octene, 2-methyl-2-octene, 3-methyl-2-octene, 4-methyl-2-octene, 5-methyl-2-octene, 6-methyl-2-octene, 7-methyl-2-octene, 3-octene, 2-methyl-3-octene, 3-methyl-3-octene, 4-methyl-3-octene, 5-methyl-3-octene, 6-methyl-3-octene, 7-methyl-3-octene, 4-octene, 2-methyl-4-octene, 3-methyl-4-octene, 4-methyl-4-octene, 5-methyl-4-octene, 6-methyl-4-octene, 7-methyl-4-octene, 7,7-dimethyl-1-octene, 3,3-dimethyl-1-octene, 4,7-dimethyl-1-octene, 2,7-dimethyl-2-octene, 2,3-dimethyl-2-octene, 3,6-dimethyl-2-octene, 4,5-dimethyl-2-octene, 4,6-dimethyl-2-octene, 4,7-dimethyl-2-octene, 4-ethyl-3-octene, 2,7-dimethyl-3-octene, 4,7-dimethyl-3-octene, 2,5-dimethyl-4-octene, 1-nonene, 2-methyl-1-nonene, 3-methyl-1-nonene, 4-methyl-1-nonene, 5-methyl-1-nonene, 6-methyl-1-nonene, 7-methyl-1-nonene, 8-methyl-1-nonene, 2-nonene, 2-methyl-2-nonene, 3-methyl-2-nonene, 4-methyl-2-nonene, 5-methyl-2-nonene, 6-methyl-2-nonene, 7-methyl-2-nonene, 8-methyl-2-nonene, 3-nonene, 2-methyl-3-nonene, 3-methyl-3-nonene, 4-methyl-3-nonene, 5-methyl-3-nonene, 6-methyl-3-nonene, 7-methyl-3-nonene, 8-methyl-3-nonene, 4-nonene, 2-methyl-4-nonene, 3-methyl-4-nonene, 4-methyl-4-nonene, 5-methyl-4-nonene, 6-methyl-4-nonene, 7-methyl-4-nonene, 8-methyl-4-nonene, 4,8-dimethyl-1-nonene, 4,8-dimethyl-4-nonene, 2,8-dimethyl-4-nonene, 1-decene, 2-methyl-1-decene, 3-methyl-1-decene, 4-methyl-1-decene, 5-methyl-1-decene, 6-methyl-1-decene, 7-methyl-1-decene, 8-methyl-1-decene, 9-methyl-1-decene, 2-decene, 2-methyl-2-decene, 3-methyl-2-decene, 4-methyl-2-decene, 5-methyl-2-decene, 6-methyl-2-decene, 7-methyl-2-decene, 8-methyl-2-decene, 9-methyl-2-decene, 3-decene, 2-methyl-3-decene, 3-methyl-3-decene, 4-methyl-3-decene, 5-methyl-3-decene, 6-methyl-3-decene, 7-methyl-3-decene, 8-methyl-3-decene, 9-methyl-3-decene, 4-decene, 2-methyl-4-decene, 3-methyl-4-decene, 4-methyl-4-decene, 5-methyl-4-decene, 6-methyl-4-decene, 7-methyl-4-decene, 8-methyl-4-decene, 9-methyl-4-decene, 5-decene, 2-methyl-5-decene, 3-methyl-5-decene, 4-methyl-5-decene, 5-methyl-5-decene, 6-methyl-5-decene, 7-methyl-5-decene, 8-methyl-5-decene, 9-methyl-5-decene, 2,4-dimethyl-1-decene, 2,4-dimethyl-2-decene, 4,8-dimethyl-1-decene, 1-undecene, 2-methyl-1-undecene, 3-methyl-1-undecene, 4-methyl-1-undecene, 5-methyl-1-undecene, 6-methyl-1-undecene, 7-methyl-1-undecene, 8-methyl-1-undecene, 9-methyl-1-undecene, 10-methyl-1-undecene, 2-undecene, 2-methyl-2-undecene, 3-methyl-2-undecene, 4-methyl-2-undecene, 5-methyl-2-undecene, 6-methyl-2-undecene, 7-methyl-2-undecene, 8-methyl-2-undecene, 9-methyl-2-undecene, 10-methyl-2-undecene, 3-undecene, 2-methyl-3-undecene, 3-methyl-3-undecene, 4-methyl-3-undecene, 5-methyl-3-undecene, 6-methyl-3-undecene, 7-methyl-3-undecene, 8-methyl-3-undecene, 9-methyl-3-undecene, 10-methyl-3-undecene, 4-undecene, 2-methyl-4-undecene, 3-methyl-4-undecene, 4-methyl-4-undecene, 5-methyl-4-undecene, 6-methyl-4-undecene, 7-methyl-4-undecene, 8-methyl-4-undecene, 9-methyl-4-undecene, 10-methyl-4-undecene, 5-undecene, 2-methyl-5-undecene, 3-methyl-5-undecene, 4-methyl-5-undecene, 5-methyl-5-undecene, 6-methyl-5-undecene, 7-methyl-5-undecene, 8-methyl-5-undecene, 9-methyl-5-undecene, 10-methyl-5-undecene, 1-dodecene, 2-dodecene, 3-dodecene, 4-dodecene, 5-dodecene, or 6-dodecene, and also the following cyclic alkenes, cyclopentene, 2-methyl-1-cyclopentene, 3-methyl-1-cyclopentene, 4-methylcyclo-1-pentene, 3-butyl-1-cyclopentene, vinylcyclopentane, cyclohexene, 2-methyl-1-cyclohexene, 3-methyl-1-cyclohexene, 4-methyl-1-cyclohexene, 1,4-dimethyl-1-cyclohexene, 3,3,5-trimethyl-1-cyclohexene, 4-cyclopentyl-1-cyclohexene, vinylcyclohexane, cycloheptene, 1,2-dimethyl-1-cycloheptene, cyclooctene, 2-methyl-1-cyclooctene, 3-methyl-1-cyclooctene, 4-methyl-1-cyclooctene, 5-methyl-1-cyclooctene, cyclononene, cyclodecene, cycloundecene, cyclododecene, bicyclo[2.2.1]-2-heptene, 5-ethylbicyclo[2.2.1]-2-heptene, 2-methylbicyclo[2.2.2]-2-octene, bicyclo[3.3.1]-2-nonene, or bicyclo[3.2.2]-6-nonene.

It is preferable to use the 1-alkenes, such as ethene, propene, 1-butene, 1-pentene, 1-hexene, 1-heptene, 1-octene, 1-nonene, 1-decene, 1-undecene, 1-dodecene, 2,4,4-trimethyl-1-pentene, 2,4-dimethyl-1-hexene, 6,6-dimethyl-1-heptene, or 2-methyl-1-octene. As monomer A it is advantageous to use an alkene having from 6 to 8 carbon atoms, preferably a 1-alkene having from 6 to 8 carbon atoms. It is particularly preferable to use 1-hexene, 1-heptene, or 1-octene. It is also possible, of course, to use a mixture of abovementioned monomers A. It is also possible to use gas mixtures which comprise monomers A. In one preferred embodiment, C4 cuts from a naphtha cracker are used, in particular the raffinate II cut (composed of from 30 to 50% by weight of n-1-butene, from 30 to 50% by weight of n-2-butene, from 10 to 30% by weight of n-butane, and <10% by weight of other compounds).

The monomers B used comprise esters based on an α,β-monoethylenically unsaturated mono- or dicarboxylic acid which has from 3 to 6 carbon atoms, in particular which has 3 or 4 carbon atoms, such as in particular acrylic acid, methacrylic acid, maleic acid, fumaric acid, and itaconic acid, and on an alkanol which has from 1 to 18 carbon atoms, preferably on an alkanol which has from 1 to 8 carbon atoms, and in particular on an alkanol which has from 1 to 4 carbon atoms, such as in particular methanol, ethanol, n-propanol, isopropanol, n-butanol, 2-methyl-1-propanol, tert-butanol, n-pentanol, 3-methyl-1-butanol, n-hexanol, 4-methyl-1-pentanol, n-heptanol, 5-methyl-1-hexanol, n-octanol, 6-methyl-1-heptanol, n-nonanol, 7-methyl-1-octanol, n-decanol, 8-methyl-1-nonanol, n-dodecanol, 9-methyl-1-decanol, or 2-ethyl-1-hexanol. It is preferable to use the methyl, ethyl, n-butyl, isobutyl, pentyl, hexyl, heptyl, octyl, nonyl, decyl, 2-ethylhexyl, or dodecyl ester of acrylic acid or of methacrylic acid, or the dimethyl or di-n-butyl ester of fumaric acid or of maleic acid. It is, of course, also possible to use a mixture of abovementioned esters.

Monomers C have at least two unconjugated ethylenically unsaturated double bonds. Examples of these are monomers which have two vinyl radicals, monomers which have two vinylidene radicals, and also monomers which have two alkenyl radicals. The diesters of dihydric alcohols with α,β-monoethylenically unsaturated monocarboxylic acid, among these preferably acrylic and methacrylic acid, are particularly advantageous. Examples of these monomers which have two unconjugated ethylenically unsaturated double bonds are alkylene glycol diacrylates and alkylene glycol dimethacrylates, e.g. ethylene glycol diacrylate, propylene 1,2-glycol diacrylate, propylene 1,3-glycol diacrylate, butylene 1,3-glycol diacrylate, butylene 1,4-glycol diacrylates, and ethylene glycol dimethacrylate, propylene 1,2-glycol dimethacrylate, propylene 1,3-glycol dimethacrylate, butylene 1,3-glycol dimethacrylate, butylene 1,4-glycol dimethacrylate, and also divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate, or triallyl isocyanurate. It is, of course, also possible to use a mixture of abovementioned compounds.

Monomers D used optionally are α,β-monoethylenically unsaturated mono- or dicarboxylic acids which have from 3 to 6 carbon atoms and/or amides of these, such as in particular acrylic acid, methacrylic acid, maleic acid, fumaric acid or itaconic acid, or acrylamide or methacrylamide. It is, of course, also possible to use a mixture of abovementioned monomers D.

Examples of monomers E used, which differ from the monomers A to D, are α,β-ethylenically unsaturated compounds such as vinylaromatic monomers, e.g. styrene, α-methylstyrene, o-chlorostyrene or vinyltoluenes, vinyl halides, such as vinyl chloride or vinylidene chloride, esters composed of vinyl alcohol and of monocarboxylic acid which have from 1 to 18 carbon atoms, e.g. vinyl acetate, vinyl propionate, vinyl n-butyrate, vinyl laurate, and vinyl stearate, nitriles of α,β-mono- or diethylenically unsaturated carboxylic acids, e.g. acrylonitrile, methacrylonitrile, fumaronitrile, maleonitrile, and also conjugated dienes which have from 4 to 8 carbon atoms, e.g. 1,3-butadiene and isoprene, and also vinylsulfonic acid, 2-acrylamido-2-methylpropanesulfonic acid, styrenesulfonic acid, and water-soluble salts thereof, and also N-vinylpyrrolidone, 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide, or 2-(1-imidazolin-2-onyl)ethyl methacrylate. Other monomers D have at least one epoxy, hydroxy, N-methylol, or carbonyl group. Other compounds of particular importance in this connection are the C₁-C₈-hydroxyalkyl esters of methacrylic and acrylic acid, e.g. n-hydroxyethyl, n-hydroxypropyl, or n-hydroxybutyl acrylate and corresponding methacrylates, and also compounds such as glycidyl acrylate or glycidyl methacrylate, diacetone acrylamide, and acetylacetoxyethyl acrylate and the corresponding methacrylate. It is, of course, also possible to use a mixture of monomers E.

However, the compounds preferably used for the free-radical-initiated aqueous emulsion polymerization of the polymer A are
from 1 to 49.99% by weight of monomers A, and
from 50 to 98.99% by weight of monomers B, and
from 0.1 to 10% by weight of monomers C.

Compounds particularly used as monomers A are 1-butene, 2-methylpropene, 1-pentene, 1-hexene, 1-heptene, 1-octene, 3-methyl-1-hexene, 3-methyl-1-heptene, and/or 3-methyl-1-octene, and compounds particularly used as monomers B are n-butyl acrylate, 2-ethylhexyl acrylate, and compounds particularly used as monomers C are allyl methacrylate, ethylene glycol diacrylate, and butylene 1,4-glycol diacrylate.

Compounds particularly preferably used for the free-radical-initiated aqueous emulsion polymerization of the polymer A are
from 5 to 40% by weight of 1-pentene, 1-hexene, and/or 1-octene [monomers A], and
from 58 to 94.9% by weight of n-butyl acrylate and/or 2-ethylhexyl acrylate [monomers B], and
from 0.1 to 2% by weight of allyl methacrylate and/or butylene 1,4-glycol diacrylate [monomers C].

The selection of monomers for the polymer A is such as to give the polymer A a glass transition temperature <0° C. The glass transition temperature of the polymer A is particularly preferably <−40° C.

Any of the monomers capable of free-radical polymerization are suitable as monomers for the polymer B, examples being those mentioned as monomers A-E.

The polymer B can be a crosslinked polymer. The polymer B is preferably a non-crosslinked polymer.

The selection of the monomers for the polymer B is preferably such as to give the polymer B a glass transition temperature >20° C. The glass transition temperature of the polymer B is particularly preferably >50° C.

In one preferred variant, the polymer B is composed of monomer units having compatibility with the thermoplastic matrix. In one particularly preferred variant, the polymer B is a copolymer with >50% by weight methyl methacrylate content.

A quantitative proportion of polymer A and polymer B is to be selected in such a way that the proportion of the crosslinked polymer A is >50% by weight. It is known that when a rubber-containing polymer powder is used as impact modifier for thermoplastics the efficiency of the impact-modifying action rises as the proportion of the rubber phase increases. Preference is therefore given to >70% content of polymer A. >85% content of polymer A is particularly preferred. It is moreover known that the resultant powder properties become less advantageous as rubber content rises. If the content of the hard shell polymer B is very small, this shell becomes to some extent non-coherent, and this type of high content of the soft core polymer A therefore makes the dried polymer very tacky. The tackiness markedly impairs powder properties, and the powder becomes less flowable. >3% content of polymer B is therefore preferred. >5% content of polymer B is particularly preferred.

When the polymer A is prepared via aqueous free-radical emulsion polymerization, at least some of the amount of the monomers A to E can always be used as an initial charge in the aqueous reaction medium, and any remaining residual amount can be added to the aqueous reaction medium after initiation of the free-radical polymerization reaction, batchwise in one portion, batchwise in a plurality of portions, or else continuously with constant or changing flow rate. Furthermore, it is also possible to use at least some of the amount of the free-radical polymerization initiator as initial charge in the aqueous reaction medium, and to heat the resultant aqueous reaction medium to polymerization temperature, and, at this temperature, to add the monomers A to E to the aqueous reaction medium batchwise in one portion, batchwise in a plurality of portions, or else continuously with constant or changing flow rate. In a particularly advantageous method, the monomers A to E are added to the aqueous reaction medium in the form of a mixture. It is advantageous to add the monomers A to E in the form of an aqueous monomer emulsion.

When the polymer B is prepared via aqueous free-radical emulsion polymerization in the presence of polymer A, the monomers are advantageously added to the aqueous reaction medium continuously in one or more portions with constant or changing flow rates. In a particularly advantageous method, the monomers are added to the aqueous reaction medium in the form of a mixture. It is advantageous to add the monomers in the form of an aqueous monomer emulsion.

According to the invention, for the purposes of the present process, concomitant use is made of dispersing agents, which keep not only the monomer droplets but also the polymer particles formed in dispersion in the aqueous medium and ensure that the aqueous polymer dispersion produced has stability. Dispersing agents that can be used are not only the protective colloids usually used for conduct of free-radical aqueous emulsions polymerizations but also emulsifiers.

Examples of suitable protective colloids are polyvinyl alcohols, polyalkylene glycols, the alkali metal salts of polyacrylic acids and polymethacrylic acids, gelatin derivatives, or copolymers comprising acrylic acid, methacrylic acid, maleic anhydride, 2-acrylamido-2-methylpropanesulfonic acid, and/or 4-styrenesulfonic acid, and the alkali metal salts of these copolymers, and also homo- and copolymers comprising N-vinylpyrrolidone, N-vinylcaprolactam, N-vinylcarbazole, 1-vinylimidazole, 2-vinylimidazole, 2-vinylpyridine, 4-vinylpyridine, acrylamide, methacrylamide, amine-group-bearing acrylates, methacrylates, acrylamides, and/or methacrylamides. Houben-Weyl, Methoden der organischen Chemie [Methods of organic chemistry], volume XIV/1, Makromolekulare Stoffe [Macromolecular substances], Georg-Thieme-Verlag, Stuttgart, 1961, pages 411 to 420 gives a detailed description of other suitable protective colloids.

It is, of course, also possible to use a mixture composed of protective colloids and/or of emulsifiers. The dispersing agents used often comprise exclusively emulsifiers whose molecular weights, unlike those of the protective colloids, are usually below 1000. They can be either anionic, cationic, or non-ionic. If mixtures of surfactants are used, the individual components must, of course, be compatible with one another, and a few preliminary experiments can be used to check this in case of doubt. Anionic emulsifiers are generally compatible with one another and with non-ionic emulsifiers. The same also applies to cationic emulsifiers, while anionic and cationic emulsifiers are mostly not compatible with one another. Houben-Weyl, Methoden der organischen Chemie [Methods of organic chemistry], volume XIV/1, Makromolekulare Stoffe [Macromolecular substances], Georg-Thieme-Verlag, Stuttgart, 1961, pages 192 to 208 gives an overview of suitable emulsifiers.

According to the invention, however, emulsifiers are particularly used as dispersing agents.

Examples of frequently used nonionic emulsifiers are ethoxylated mono-, di- and trialkylphenols (EO number: from 3 to 50, alkyl radical: C₄-C₁₂), and also ethoxylated fatty alcohols (EO number: from 3 to 80, alkyl radical: C₈-C₃₆). Examples of these are Lutensor A grades (C₁₂-C₁₄ fatty alcohol ethoxylates, EO number: from 3 to 8), Lutensol® AO grades (C₁₃-C₁₅ oxo alcohol ethoxylates, EO number: from 3 to 30), Lutensol® AT grades (C₁₆-C₁₈ fatty alcohol ethoxylates, EO number: from 11 to 80), Lutensol® ON grades (C₁₀ oxo alcohol ethoxylates, EO number: from 3 to 11) and Lutensol® TO grades (C₁₃ oxo alcohol ethoxylates, EO number: from 3 to 20) from BASF AG. Examples of usual anionic emulsifiers are the alkali metal and ammonium salts of alkyl sulfates (alkyl radical: C₈-C₁₂), of sulfuric half-esters of ethoxylated alkanols (EO number: from 4 to 30, alkyl radical: C₁₂-C₁₈) or of ethoxylated alkylphenols (EO number: from 3 to 50, alkyl radical: C₄-C₁₂), of alkylsulfonic acids (alkyl radical: C₁₂-C₁₈) or of alkylarylsulfonic acids (alkyl radical: C₉-C₁₈).

Other anionic emulsifiers which have proven suitable are compounds of the formula (I)

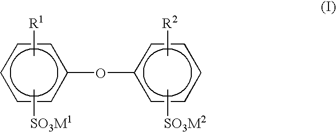

where R¹ and R² are H or C₄-C₂₄-alkyl, but not simultaneously hydrogen, and M¹ and M² may be alkali metal ions and/or ammonium ions. In the general formula (I) R¹ and R² are preferably linear or branched alkyl radicals having from 6 to 18 carbon atoms, in particular having 6, 12 or 16 carbon atoms, or H, but R¹ and R² are not simultaneously H. M¹ and M² are preferably sodium, potassium or ammonium, particularly preferably sodium. Particularly advantageous compounds (I) are those where M¹ and M² is sodium, R¹ is a branched alkyl radical having 12 carbon atoms and R² is H or R¹. Use is frequently made of technical mixtures which have from 50 to 90% by weight content of the monoalkylated product, for example Dowfax® 2A1 (trademark of Dow Chemical Company). The compounds (I) are well known, e.g. from U.S. Pat. No. 4,269,749, and are available commercially.

Suitable cationic emulsifiers are generally C₆-C₁₈-alkyl-bearing or C₆-C₁₈-aralkyl-bearing or heterocyclic-radical-bearing primary, secondary, tertiary or quaternary ammonium salts, alkanolammonium salts, pyridinium salts, imidazolinium salts, oxazolinium salts, morpholinium salts, thiazolinium salts, or else salts of amine oxides, or are quinolinium salts, isoquinolinium salts, tropylium salts, sulfonium salts or phosphonium salts. Examples of these are dodecylammonium acetate and the corresponding sulfate, the sulfate or acetates of the various 2-(N,N,N-trimethyl-ammonium)ethyl paraffinates, N-cetylpyridinium sulfate, N-laurylpyridinium sulfate, and also N-cetyl-N,N,N-trimethyl ammonium sulfate, N-dodecyl-N,N,N-trimethylammonium sulfate, N-octyl-N,N,N-trimethlyammonium sulfate, N,N-distearyl-N,N-dimethylammonium sulfate, and also the gemini surfactant N,N′-(lauryldimethyl)ethylenediamine disulfate, ethoxylated tallow fatty alkyl-n-methylammonium sulfate, and ethoxylated oleylamine (for example Uniperol® AC from BASF AG, about 12 ethylene oxide units). Numerous other examples are found in H. Stache, Tensid-Taschenbuch, Carl-Hanser-Verlag, Munich, Vienna, 1981 and in McCutcheon's, Emulsifiers & Detergents, MC Publishing Company, Glen Rock, 1989. It is advantageous that the anionic counter-groups have minimum nucleophilicity, examples being perchlorate, sulfate, phosphate, nitrate, and carboxylates, such as acetate, trifluoroacetate, trichloroacetate, propionate, oxalate, citrate, benzoate, and also conjugated anions of organosulfonic acids, e.g. methylsulfonate, trifluoromethylsulfonate, and para-toluenesulfonate, and also tetrafluoroborate, tetraphenylborate, tetrakis(pentafluorophenyl)borate, tetrakis[bis(3,5-trifluoromethyl)phenyl]borate, hexafluorophosphate, hexafluoroarsenate, or hexafluoroantimonate.

The total amount used of the emulsifiers preferably used as dispersing agents is in each case based on the total amount of monomer, ≧0.005 and ≦10% by weight, preferably ≧0.01 and ≦5% by weight, in particular ≧0.1 and ≦3% by weight.

The total amount used of the protective colloids used as dispersing agents in addition to or instead of the emulsifiers, in each case based on the total amount of monomer, is often ≧0.1 and ≦10% by weight and frequently ≧0.2 and ≦7% by weight.

However, it is preferable that anionic and/or non-ionic emulsifiers, and particularly preferably anionic emulsifiers, are used as dispersing agents.

The free-radical-initiated aqueous emulsion polymerization is initiated by means of a free-radical polymerization initiator (free-radical initiator). In principle, these can be either peroxides or azo compounds. Redox initiator systems can, of course, also be used. Peroxides that can in principle be used are inorganic peroxides, such as hydrogen peroxide or peroxodisulfates, such as the mono- or di-alkali-metal or ammonium salts of peroxodisulfuric acid, e.g. its mono- and disodium, -potassium, or ammonium salts, or organic peroxides, such as alkyl hydroperoxides, e.g. tert-butyl, p-menthyl, or cumyl hydroperoxide, and also dialkyl or diaryl peroxides, such as di-tert-butyl or dicumyl peroxide. The azo compound used in essence comprises 2,2″-azobis(isobutyronitrile), 2,2′-azobis(2,4-dimethylvaleronitrile), and 2,2″-azobis(amidinopropyl)dihydrochloride (AIBA, corresponding to V-50 from Wako Chemicals). Oxidants used for redox initiator systems are in essence the abovementioned peroxides. The corresponding reducing agent used can comprise sulfur compounds with a low oxidation state, e.g. alkali metal sulfites, such as potassium sulfite and/or sodium sulfite, alkali metal hydrogensulfites, such as potassium hydrogensulfite and/or sodium hydrogensulfite, alkali metal metabisulfites, such as potassium metabisulfite and/or sodium metabisulfite, formaldehyde sulfoxylates, such as potassium formaldehyde-sulfoxylate and/or sodium formaldehyde-sulfoxylate, alkali metal salts, specifically the potassium and/or sodium salts of aliphatic sulfinic acids, and alkali metal hydrogensulfides, such as potassium hydrogensulfide and/or sodium hydrogensulfide, salts of polyvalent metals, e.g. ferrous sulfate, ferrous ammonium sulfate, ferrous phosphate, enediols, such as dihydroxymaleic acid, benzoin, and/or ascorbic acid, and also reducing saccharides, such as sorbose, glucose, fructose, and/or dihydroxyacetone. The amount of the free-radical initiator used, based on the total amount of monomer, is generally from 0.01 to 5% by weight, preferably from 0.1 to 3% by weight, and particularly preferably from 0.2 to 1.5% by weight.

According to the invention, the entire amount of the free-radical initiator can be used as an initial charge in the aqueous reaction medium. However, it is also possible, if appropriate, to use merely a portion of the free-radical initiator in the aqueous reaction medium and then, during the inventive free-radical emulsion polymerization, to add the entire amount or any remaining residual amount, as required by consumption, continuously or batchwise.

The entire range from 0 to 170° C. can be used as reaction temperature for the inventive free-radical aqueous emulsion polymerization. Temperatures used here are generally from 50 to 120° C., frequently from 60 to 110° C., and often from 70 to 100° C. The inventive free-radical aqueous emulsion polymerization can be carried out at a pressure smaller, than, equal to, or greater than 1 bar (absolute), and the polymerization temperature can therefore exceed 100° C. and can be up to 170° C. It is preferable to use superatmospheric pressure for polymerizing volatile monomers, such as 2-methyl-1-butene, 3-methyl-1-butene, 2-methyl-2-butene, butadiene, 2-butene, 2-methylpropene, propene, ethylene, or vinyl chloride. The pressure here can assume values of 1.2, 1.5, 2, 5, 10, 15, 50, or 100 bar, or even higher values. If emulsion polymerizations are carried out at subatmospheric pressure, the pressures set are 950 mbar, frequently 900 mbar, and often 850 mbar (absolute). The inventive free-radical aqueous emulsion polymerization is advantageously carried out at 1 atm (1.01 bar absolute) under inert gas, for example under nitrogen or argon.

In principle, the aqueous reaction medium can also comprise subordinate amounts of water-soluble organic solvents, such as methanol, ethanol, isopropanol, butanols, pentanols, or else acetone, etc. However, the inventive process is preferably carried out in the absence of such solvents.

Alongside the abovementioned components, it is also possible and optional to use, in the inventive process, free-radical chain-transfer compounds, in order to reduce or control the molecular weight of the polymers obtainable via the polymerization. Compounds used here are in essence aliphatic and/or araliphatic halogen compounds, such as n-butyl chloride, n-butyl bromide, n-butyl iodide, methylene chloride, ethylene dichloride, chloroform, bromoform, bromotrichloromethane, dibromodichloromethane, carbon tetrachloride, carbon tetrabromide, benzyl chloride, benzyl bromide, organic thio compounds, such as primary, secondary, or tertiary aliphatic thiols, e.g. ethanethiol, n-propanethiol, 2-propanethiol, n-butanethiol, 2-butanethiol, 2-methyl-2-propanethiol, n-pentanethiol, 2-pentanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and its isomeric compounds, n-octanethiol and its isomeric compounds, n-nonanethiol and its isomeric compounds, n-decanethiol and its isomeric compounds, n-undecanethiol and its isomeric compounds, n-dodecanethiol and its isomeric compounds, n-tridecanethiol and its isomeric compounds, substituted thiols, such as 2-hydroxyethanethiol, aromatic thiols, such as benzenethiol, ortho-, meta-, or para-methylbenzenethiol, and also all of the other sulfur compounds described in Polymer Handbook 3^{rd} edition, 1989, J. Brandrup and E. H. Immergut, John Wiley & Sons, Section II, pages 133-141, and also aliphatic and/or aromatic aldehyde, such as acetaldehyde, propionaldehyde, and/or benzaldehyde, unsaturated fatty acids, such as oleic acid, dienes having unconjugated double bonds, e.g. divinylmethane or vinylcyclohexane, or hydrocarbons having readily extractable hydrogen atoms, e.g. toluene. However, it is also possible to use a mixture of abovementioned free-radical chain-transfer compounds which do not interfere with one another.

The entire amount of the free-radical chain-transfer compounds optionally used in the inventive process, based on the total amount of monomer, is generally ≦5% by weight, often ≦3% by weight, and frequently ≦1% by weight.

It is advantageous that a portion or the entire amount of the optionally used free-radical chain-transfer compound is added to the reaction medium prior to initiation of the free-radical polymerization. Furthermore, in another advantageous method, a portion or the entire amount of the free-radical chain-transfer compound can be added to the aqueous reaction medium together with the monomers A to D during the polymerization.

The free-radical-initiated aqueous emulsion polymerization can optionally also be carried out in the presence of a polymer seed, for example in the presence of, in each case based on the total amount of monomer, from 0.01 to 3% by weight, frequently from 0.02 to 2% by weight, and often from 0.04 to 1.5% by weight, of a polymer seed.

A polymer seed is used in particular when the size of the polymer particles to be prepared by means of aqueous free-radical emulsion polymerization is to be set in a controlled manner (in which connection see by way of example U.S. Pat. No. 2,520,959 and U.S. Pat. No. 3,397,165).

Particular polymer seed used has polymer seed particles with narrow particle size distribution and with weight-average diameter D_{w}≦100 nm, frequently ≧5 nm to ≦50 nm, and often ≧15 nm to ≦35 nm. The method for determining weight-average particle diameter is known to the person skilled in the art and by way of example uses the analytical ultracentrifuge. In this specification, weight-average particle diameter means the weight-average D_{w50} value determined by the analytical ultracentrifuge method (cf. in this connection S. E. Harding et al., Analytical Ultracentrifugation in Biochemistry and Polymer Science, Royal Society of Chemistry, Cambridge, Great Britain 1992, Chapter 10, Analysis of Polymer Dispersions with an Eight-Cell-AUC-Multiplexer: High Resolution Particle Size Distribution and Density Gradient Techniques, W. Mächtle, pages 147-175).

For the purposes of this specification, narrow particle size distribution means that the ratio of the weight-average particle diameter D_{w50} to the number-average particle diameter D_{N50} [D_{w50}/D_{N50}] is ≦2.0, preferably ≦1.5, and particularly preferably ≦1.2 or ≦1.1, determined by the analytical ultracentrifuge method.

The form in which the polymer seed is used is usually that of an aqueous polymer dispersion. In this case, the abovementioned quantitative data are based on the polymer solids content of the aqueous polymer dispersion; they are therefore stated in terms of parts by weight of polymer seed solids, based on the total amount of monomer.

If a polymer seed is used, it is advantageous to use a foreign polymer seed. Unlike in what is known as in-situ polymer seed, which is prepared prior to the start of the actual emulsion polymerization in the reaction vessel, and whose monomeric constitution is the same as that of the polymer prepared via the subsequent free-radical-initiated aqueous emulsion polymerization, a foreign polymer seed is a polymer seed which has been prepared in a separate reaction step and whose monomeric constitution differs from that of the polymer prepared via the free-radical-initiated aqueous emulsion polymerization. This simply means that different monomers or monomer mixtures with different constitution are used for preparation of the foreign polymer seed and for preparation of the aqueous polymer dispersion. Preparation of a foreign polymer seed is familiar to the person skilled in the art, and usually proceeds by using a relatively small amount of monomers and a relatively large amount of emulsifiers as initial charge in a reaction vessel and adding a sufficient amount of polymerization initiator at reaction temperature.

According to the invention, it is preferable to use a foreign polymer seed whose glass transition temperature is ≧50° C., frequently ≧60° C. or ≧70° C., and often ≧80° C. or ≧90° C. Particular preference is given to a polystyrene polymer seed or a polymethyl methacrylate polymer seed.

The entire amount of foreign polymer seed can be used as initial charge prior to the start of addition of the monomers A to E in the reaction vessel. However, it is also possible to use merely some of the amount of the foreign polymer seed as initial charge prior to the start of addition of the monomers A to E in the reaction vessel, and to add the remaining amount during the polymerization. However, it is also possible, if required, to add the entire amount of polymer seed during the course of the polymerization. It is preferable that the entire amount of foreign polymer seed is used as initial charge prior to the start of addition of the monomers A to E in the reaction vessel.

The number-average particle diameter (cumulant z-average) of the polymer B prepared via aqueous free-radical emulsion polymerization in the presence of polymer A, determined by way of quasi-elastic light scattering (ISO standard 13 321) is from 60-500 nm, preferably from 80-320 nm, particularly preferably from 150-300 nm. The polymer B here can have bi- or multimodal particle size distribution.

The usual polymer solids content of the aqueous polymer dispersion obtained according to the invention is usually ≧10 and ≦80% by weight, frequently ≧20 and ≦70% by weight, and often ≧25 and ≦60% by weight, based in each case on the aqueous polymer dispersion.

Chemical and/or physical methods likewise known to the person skilled in the art are frequently used on the resultant aqueous polymer dispersions, in order to remove residual contents of unreacted monomers and of other low-boiling-point compounds [by way of example EP-A 771328, DE-A 196 24 299, DE-A 196 21 027, DE-A 197 41 184, DE-A 197 41 187, DE-A 198 05 122, DE-A 198 28 183, DE-A 198 39 199, DE-A 198 40 586, and 198 47 115].

The polymer obtained from aqueous free-radical emulsion polymerization is converted to a polymer powder via drying techniques known to the person skilled in the art. Coagulation or spray drying can be used for the conversion to a powder. Prior to or during drying, specific additives can be added to the dispersion in order to improve powder properties, examples being antioxidants, powder-flow aids, and antiblocking agents.

The form used of the antioxidants when they are admixed with the polymer dispersion is that of pellets, or of pulverulent solid, or preferably of a dispersion. Addition of anti-oxidants is described by way of example in EP 44 159 and EP 751 175. Antioxidants are in particular added in order to avoid spontaneous heating and spontaneous ignition of the dried product during storage and transport. Preferred antioxidants are those selected from the class of the sterically hindered alkylphenols or their condensates. Possible antioxidants can be found in Plastics Additives Handbook, 5th ed., Munich 2000, 1-139, Hanser Verlag.

The amounts added of the powder-flow aids and antiblocking agents are from 0.1 to 15% by weight, preferably from 3 to 8% by weight. In one preferred embodiment, hydrophobicized powder-flow aids and antiblocking agents are used. Powder-flow aids and antiblocking agents are fine-particle powders, for example composed of calcium carbonate, talc, or silicas. Examples of hydrophobicized powder-flow aids and antiblocking agents are calcium carbonate coated with fatty acids or with fatty alcohols, for example with stearic acid or with palmitic acid, or silicas chemically modified via surface treatment with reactive silanes, for example with chlorosilanes or with hexamethyldisilazane. It is preferable to use stearic-acid-coated calcium carbonate. The primary particle size of the powder-flow aids and antiblocking agents is preferably smaller than 100 nm.

To improve powder properties and to comminute the powder obtained from drying, mills known to the person skilled in the art can optionally be used in a subsequent step for fine grinding. These are cutting mills, impact mills, such as rotor-impact mills or jet-impact mills, roller mills, such as rolling mills, roll mills, or grinding rolls, mills comprising grinding materials, e.g. ball mills, rod mills, autogenous mills, planetary mills, vibratory mills, centrifugal mills, or stirrer mills, and also milling dryers. Comminution machinery is described in Ullmann's Encyclopedia of Industrial Chemistry, 6th ed. Vol. 11, p. 70 and Vol. 33, p. 41-81. It is preferable to use mills which have sieve classification, and particularly preferred equipment is fine granulators with sieves and fine granulators with rotors (grater-shredders).

The inventive molding compositions can be prepared from the inventive polymer powder in any desired manner by any of the known methods.

The invention also provides the use of the molding compositions described for production of moldings, such as profiles, sheets or semifinished products, foils, fibers, or foams. Processing can be carried out by means of the known processes for thermoplastics processing, and particular production methods are thermoforming, extrusion, injection molding, calendaring, blow molding, compression molding, pressure sintering, or other methods of sintering, preferably extrusion.

The non-limiting examples below are intended for illustration of the invention.

### Preparation of the Dispersion

Solids content was determined by drying a defined amount of the aqueous polymer dispersion (about 5 g) at 140° C. in a drying cabinet to constant weight. Two separate measurements were made. The value stated in the example is the average of the two test results.

Glass transition temperature was determined to DIN 53765 by means of a series TA 8000 DSC 820 device from Mettler-Toledo.

### INVENTIVE EXAMPLE 1

230 g of deionized water, 10.2 g of an aqueous polystyrene seed (solids content 33% by weight, number-average particle diameter 32 nm), 60.0 g of 1-octene, and 0.84 g of sodium persulfate were used as initial charge in a 2 l four-necked flask equipped with anchor stirrer, reflux condenser, and two feed systems, under nitrogen, and were heated to 90° C., with stirring. Monomer feed 1, composed of 133 g of deionized water, 5.6 g of a 45% strength by weight aqueous solution of Dowfax® 2A1 (product of Dow Chemical Company), 22.4 g of a 3% strength by weight aqueous solution of sodium pyrophosphate, 1.68 g of allyl methacrylate, and 317.5 g of n-butyl acrylate, and the initiator feed, composed of 70 g of deionized water and 3.36 g of sodium persulfate, were begun simultaneously once the reaction temperature of 90° C. had been reached. Monomer feed 1 was continuously metered in over 3 hours. The initiator feed was continuously metered in over 6 h. Once monomer feed 1 had ended, polymerization was continued at 90° C. for 1.5 h. Monomer feed 2, composed of 60.0 g of deionized water, 2.8 g of a 45% strength by weight aqueous solution of Dowfax® 2A1, and 42.0 g of methyl methacrylate, was then metered in continuously over 1 h. Polymerization was then continued at 90° C. for 1 h, and the dispersion was cooled to room temperature, and a pH of 7.5 was set using a 10% strength by weight aqueous solution of ammonia. The solids content of the dispersion was 43.1%. The average particle size of the dispersion was 138 nm. The lowest glass transition temperature of the polymer was −46° C.

### COMPARATIVE EXAMPLE 1

230 g of deionized water, 10.2 g of an aqueous polystyrene seed (solids content 33% by weight, number-average particle diameter 32 nm), and 0.84 g of sodium persulfate were used as initial charge in a 2 l four-necked flask equipped with anchor stirrer, reflux condenser, and two feed systems, under nitrogen, and were heated to 90° C., with stirring. Monomer feed 1, composed of 135 g of deionized water, 5.6 g of a 45% strength by weight aqueous solution of Dowfax® 2A1, 22.4 g of a 3% strength by weight aqueous solution of sodium pyrophosphate, 1.68 g of allyl methacrylate, and 376.3 g of n-butyl acrylate, and the initiator feed, composed of 70 g of deionized water and 3.36 g of sodium persulfate, were begun simultaneously once the reaction temperature of 90° C. had been reached. Monomer feed 1 was continuously metered in over 3 hours. The initiator feed was continuously metered in over 6 h. Once monomer feed 1 had ended, polymerization was continued at 90° C. for 1.5 h. Monomer feed 2, composed of 60.0 g of deionized water, 2.8 g of a 45% strength by weight aqueous solution of Dowfax® 2A1, and 42.0 g of methyl methacrylate, was then metered in continuously over 1 h. Polymerization was then continued at 90° C. for 1 h, and the dispersion was cooled to room temperature, and a pH of 7.5 was set using a 10% strength by weight aqueous solution of ammonia. The solids content of the dispersion was 44.7%. The average particle size of the dispersion was 151 nm. The lowest glass transition temperature of the polymer was −41° C.

### Preparation of Thermoplastic Molding Compositions

The dispersions of Inventive Example 1 and of Comparative Example 1 were dried at room temperature and mechanically comminuted. For this, the polymer was cooled using dry ice (solid carbon dioxide at −78° C.) and was milled using a grinder (A 10 analytical mill from Janke & Kunkel IKA Labortechnik) to give a powder.

### INVENTIVE EXAMPLE 2

A mixture composed of

100 parts of PVC powder (Solvin 265 RE, Solvin)
7 parts of Pb stabilizer (Baeropan R 2930 SP 1, Baerlocher)
6 parts of CaCO₃ (Hydrocarb 95 T, Omya), and
4 parts of TiO₂ (Kronos 2220, Kronos International)
were placed on a roll (110P twin-roll mill from Collin GmbH) together with 5 parts of the polymer powder of Inventive Example 1 and of Comparative Example 1, and a milled sheet was produced via rolling at 180° C. for 8 min. This was pressed at 190° C. for 8 min at 15 bar and then for 5 min at 200 bar to give a pressed sheet, which was cooled at 200 bar for 8 min. Test specimens were sawn from the pressed sheet and then notched. Notched impact resistances were determined by the Charpy method based on DIN 53753. The thickness of the test specimens used was 3 mm, and they were double-V-notched, notch radius 0.1 mm. The Zwick (B5102E) pendulum impact tester was used for the test, and the nominal value for the energy rating of the pendulum was 1 J. The average was calculated from ten individual measurements.

| | Notched impact | |
|---|---|---|
| Polymer powder | resistance | Standard deviation |
| Inventive Example 1 | 23.8 | 1.0 |
| Comparative Example 1 | 25.4 | 2.4 |

### INVENTIVE EXAMPLE 3

A mixture composed of

90 parts of PVC powder (Solvin 257 RF, Solvin)
0.3 part of Loxiol G72 lubricant, Cognis
0.8 part of Loxiol G16 lubricant, Cognis
1.1 parts of Sn stabilizer (Irgastab 17 MOK, Ciba)
were placed on a roll (110P twin-roll mill from Collin GmbH) together with 5 parts of the polymer powder of Inventive Example 1 and of Comparative Example 1, and a milled sheet was produced via rolling at 170° C. for 8 min. This was pressed at 180° C. for 8 min at 15 bar and then for 5 min at 200 bar to give a pressed sheet, which was cooled at 200 bar for 8 min. Test specimens were sawn from the pressed sheet and then notched. Notched impact resistances were determined as in Inventive Example 2.

| | Notched impact | |
|---|---|---|
| Polymer powder | resistance | Standard deviation |
| Inventive Example 1 | 20 | 1.0 |
| Comparative Example 1 | 16 | 0.7 |

1. A polymer powder comprising emulsion polymer particles which have a core-shell structure, with >50% content of crosslinked polymer A, where polymer A comprises, as monomer units,
from 1 to 50% by weight of at least one alkene which has from 2 to 12 carbon atoms [monomer A], and
from 30 to 99% by weight of at least one ester based on α,β-monoethylenically unsaturated mono- or dicarboxylic acid which has from 3 to 6 carbon atoms and on an alkanol which has from 1 to 18 carbon atoms [monomer B], and
from 0.1 to 20% by weight of at least one compound which has at least two unconjugated vinyl groups which has crosslinking action [monomer C], and optionally
from 0 to 10% by weight of an α,β-monoethylenically unsaturated mono- or dicarboxylic acid which has from 3 to 6 carbon atoms, and/or an amide thereof [monomer D], and
from 0 to 30% by weight of an α,β-ethylenically unsaturated compound which differs from the monomers A to D [monomer E],
wherein monomers A to E give a total of 100% by weight.

2. The polymer powder according to claim 1, where polymer A comprises
from 1 to 49.9% by weight of monomers A,
from 50 to 98.99% by weight of monomers B, and
from 0.1 to 10% by weight of monomers C.

3. The polymer powder according to claim 1, wherein the glass transition temperature of the polymer A is <−40° C.

4. The polymer powder according to claim 1, where monomer A is selected from the group consisting of ethene, propene, 1-butene, 1-pentene, 1-hexene, 1-heptene, 1-octene, 1-nonene, 1-decene, 1-undecene, 1-dodecene, 2,4,4-trimethyl-1-pentene, 2,4-dimethyl-1-hexene, 6,6-dimethyl-1-heptene, and 2-methyl-1-octene.

5. The polymer powder according to claim 1, where monomer B is one or more selected from the group consisting of: n-butyl acrylate and 2-ethylhexyl acrylate.

6. The polymer powder according to claim 1, where monomer C is one or more selected from the group consisting of: allyl methacrylate and butylene 1,4-glycol diacrylate.

7. The polymer powder according to claim 1, where polymer A comprises
from 5 to 40% by weight of 1-pentene, 1-hexene, and/or 1-octene [monomers A], and
from 58 to 94.9% by weight of n-butyl acrylate and/or 2-ethylhexyl acrylate [monomers B], and
from 0.1 to 2% by weight of allyl methacrylate and/or butylene 1,4-glycol diacrylate [monomers C].

8. An impact modifier for thermoplastics comprising halogen, comprising the polymer powder according to claim 1.

9. A polyvinyl chloride molding composition comprising the polymer powder according to claim 1.

10. A process for production of the polymer powder according to claim 1, which comprises
a) preparing the polymer A as polymer dispersion A in a first step, and
b) preparing a polymer B in the presence of a polymer dispersion A.

11. The process according to claim 10, wherein the polymer dispersion B has a core-shell structure.

12. A molding comprising the polyvinyl chloride molding composition according to claim 9.
